(19) United States
(12) Patent Application Publication
(10) Pub. No.: US 2023/0412711 A1
(43) Pub. Date: Dec. 21, 2023

(54) APPARATUS, SYSTEM, AND METHOD OF COMMUNICATING A PHYSICAL LAYER (PHY) PROTOCOL DATA UNIT (PPDU)

(71) Applicant: INTEL CORPORATION, Santa Clara, CA (US)

(72) Inventors: Juan Fang, Portland, OR (US); Qinghua Li, San Ramon, CA (US); Po-Kai Huang, San Jose, CA (US); Robert Stacey, Portland, OR (US); Laurent Cariou, Milizac (FR); Minyoung Park, San Ramon, CA (US); Dmitry Akhmetov, Hillsboro, OR (US); Hao Song, Santa Clara, CA (US)

(73) Assignee: INTEL CORPORATION, Santa Clara, CA (US)

(21) Appl. No.: 18/344,754

(22) Filed: Jun. 29, 2023

(51) Int. Cl. H04L 69/22

(52) U.S. Cl. CPC H04L 69/22

(57) ABSTRACT

For example, a wireless communication Station (STA) may be configured to generate a preamble of a Physical Layer (PHY) Protocol Data Unit (PPDU) according to a PPDU frame format. For example the STA may be configured to generate a data payload of the PPDU according to the PPDU frame format. For example, the data payload may include a plurality of data payload portions. For example, the PPDU may include a predefined Training Field (TF) between a first data payload portion and a second data payload portion of the plurality of data payload portions. For example, the STA may be configured to transmit the PPDU.

### TECHNICAL FIELD

Aspects described herein generally relate to communicating A Physical layer (PHY) Protocol Data Unit (PPDU).

### BACKGROUND

Some wireless communication networks may support communication of high-throughput data for users of wireless communication devices.

There is a need for technical solutions to provide increased and/or efficient access to the wireless communication medium.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a Physical layer (PHY) Protocol Data Unit (PPDU) frame format, in accordance with some demonstrative aspects.

FIG. 3 is a schematic illustration of an Aggregate PHY Service Data Unit (PSDU) (A-PSDU) frame format, in accordance with some demonstrative aspects.

FIG. 4 is a schematic illustration of an A-PSDU frame format, in accordance with some demonstrative aspects.

FIG. 5 is a schematic illustration of an A-PSDU frame format, in accordance with some demonstrative aspects.

FIG. 6 is a schematic illustration of a fragmented PPDU frame format, in accordance with some demonstrative aspects.

FIG. 7 is a schematic illustration of a fragmented PPDU frame format, in accordance with some demonstrative aspects.

FIG. 8 is a schematic illustration of a fragmented PPDU frame format, in accordance with some demonstrative aspects.

FIG. 9 is a schematic flow-chart illustration of a method of communicating a PPDU, in accordance with some demonstrative aspects.

FIG. 10 is a schematic flow-chart illustration of a method of communicating a PPDU, in accordance with some demonstrative aspects.

FIG. 11 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); IEEE 802.11ax (IEEE 802.11ax-2021, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications; Amendment 1: Enhancements for High-Efficiency WLAN, February 2021); and/or IEEE 802.11be (IEEE P802.11be/D3.1 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), March 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

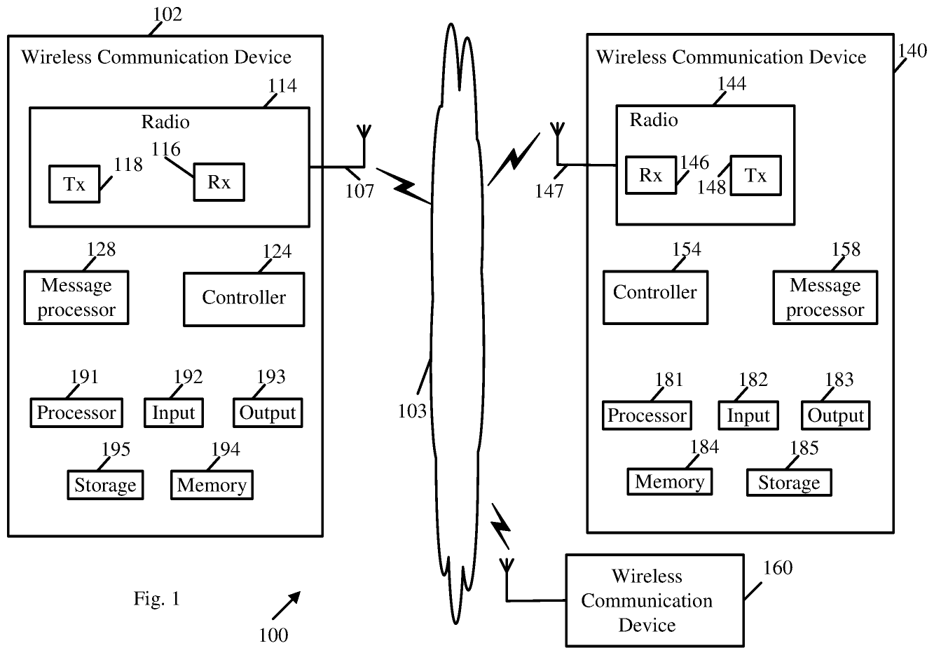

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, an IEEE 802.11be Specification, and/or any other specification and/or protocol.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-A STA.

In some demonstrative aspects, device 140 may include, operate as, perform a role of, and/or perform the functionality of, a second STA, e.g., an AP STA or a non-A STA.

In some demonstrative aspects, device 160 may include, operate as, perform a role of, and/or perform the functionality of, a third STA, e.g., an AP STA or a non-A STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to communicate one or more PPDUs, for example, in accordance with an IEEE 802.11 Specification.

In some demonstrative aspects, device 102, device 140, and/or device 160 may be configured to generate, transmit, receive, and/or process one or more transmissions of PPDUs, e.g., as described below.

In some demonstrative aspects, controller 124 may be configured to control, trigger, cause, and/or instruct device 102 to transmit the PPDUs, e.g., as described below.

In some demonstrative aspects, controller 154 may be configured to control, trigger, cause, and/or instruct device 140 to process the PPDUs, e.g., as described below.

In some demonstrative aspects, device 102, device 140, and/or device 160 may be configured to generate, transmit, receive, and/or process one or more transmissions of PPDUs according to an Aggregate PHY Service Data Unit (PSDU) (A-PSDU) format, e.g., as described below.

For example, the A-PSDU format may be configured, for example, in accordance with an IEEE 802.11 Specification.

For example, a A-PSDU format, e.g., in accordance with an IEEE 802.11 Specification, may be configured to aggregate a plurality of PSDUs, for example, within a single PPDU.

In one example, an A-PSDU format, e.g., in accordance with an IEEE 802.11 Specification, may include an HT signal (HT-SIG) field before a PSDU, e.g., before each PSDU, of the PPDU. For example, the HT-SIG field may be configured to define one or more attributes and/or parameters corresponding to the PSDU following the HT-SIG field, for example, a data rate of the PSDU following the HT-SIG field, a length of the PSDU, and/or whether the PSDU is the last PSDU in the A-PSDU.

In some demonstrative aspects, in some use cases, scenarios, and/or implementations, there may be a need to address one or more technical issues, for example, when implementing a A-PSDU format including the HT-SIG field before each PSDU, e.g., as described below.

In one example, in some deployments, for example, when a number of Wi-Fi devices within a Basic Service Set (BSS) is relatively small, the A-PSDU format including the HT-SIG field may be good enough to support high throughout. However, the A-PSDU format including the HT-SIG field may not be suitable for some deployments, for example, where a number of Wi-Fi devices within each BSS is relatively high.

In another example, the A-PSDU format including the HT-SIG field may not be suitable to support one or more Key Performance Indicator (KPI) required by users, e.g., in addition to, or instead of, high throughput. For example, high reliability and/or low latency may be important KPIs required by the users, for example, in addition to high throughout.

In some demonstrative aspects, device 102, device 140, and/or device 160 may be configured to perform one or more operations and/or functionalities of a data aggregation mechanism, for example, to support a technical solution to increase an overall throughput of Wi-Fi devices, e.g., as described below.

In some demonstrative aspects, the data aggregation mechanism may be configured to utilize Transmit Opportunities (TxOPs), and/or frame aggregation, for example, in accordance with an IEEE 802.11 Specifications, e.g., to increase overall throughput.

In some demonstrative aspects, the frame aggregation may make a data payload of an aggregated frame much bigger. Accordingly, the aggregated frame may occupy a much longer airtime, e.g., in order to achieve high throughput.

In one example, the frame aggregation may improve throughput and/or may reduce an average latency for a pair of STAs, which may communicate an aggregated frame, e.g., a long aggregated PPDU. However, the frame aggregation may result in a worst-case latency for a 3rd party STA.

For example, the 3rd party STA may wait a long time for a wireless medium to be idle, for example, due to a much longer airtime occupied by the aggregated frame communicated between the pair of STAs.

According to this example, time-sensitive frames, e.g., Low Latency (LL) frames, may experience a higher latency, for example, when a channel is occupied by a long PPDU transmission.

For example, one or more PPDU transmission techniques and/or one or more rules may be defined, for example, to support transmission of LL frames, e.g., as described below.

In one example, a long data PPDU may be divided into a plurality of PPDUs, e.g., small PPDUs, with a maximum PPDU length limitation. For example, one or more time gaps may be inserted between two consecutive PPDUs, for example, to enable a preemption opportunity for LL frame transmissions.

In another example, one or more rules may be configured to define, for example, which time gaps may be preemptable, how to avoid collisions among multiple LL transmitters, and/or how to support preemption, for example, when an LL transmitter is a hidden node to a data PPDU transmitter.

For example, one or more techniques may be implemented to support transmission of LL frames, e.g., as described below.

In one example, an Interframe Spaces (xIFS) channel access may be defined for LL transmitter, for example, differently from an xIFS channel access defined for a normal transmitter, for example, to prioritize the LL transmission.

In another example, a common preemption request frame may be defined to support LL transmission.

In some demonstrative aspects, device 102, device 140, and/or device 160 may be configured to communicate a PPDU according to a PPDU frame format, which may be configured to provide a technical solution to support communication of a plurality of data portions in a PPDU, e.g., as described below.

In some demonstrative aspects, device 102, device 140, and/or device 160 may be configured to generate, transmit, receive, and/or process the PPDU according to the PPDU frame format, e.g., as described below.

In some demonstrative aspects, controller 124 may be configured to control, trigger, cause, and/or instruct device 102 to transmit the PPDU according to the PPDU frame format, e.g., as described below.

In some demonstrative aspects, controller 154 may be configured to control, trigger, cause, and/or instruct device 140 to process the PPDU according to the PPDU frame format, e.g., as described below.

In some demonstrative aspects, the PPDU frame format may be configured to provide a technical solution to support reduced overhead, e.g., as described below.

In some demonstrative aspects, the PPDU frame format may be configured to provide a technical solution to support reduced overhead, for example, in communications according to a preemption protocol, e.g., as described below.

In some demonstrative aspects, the PPDU frame format may be configured to provide a technical solution to reduce an overhead cost of the preemption protocol, e.g., as described below.

In some demonstrative aspects, the PPDU frame format may be configured to provide a technical solution to integrate an A-PSDU frame format with the preemption protocol, for example, to reduce an overhead of an A-PSDU format, for example, compared to the overhead of an A-PSDU format including an HT-SIG field between consecutive PSDUs, e.g., as described below.

In some demonstrative aspects, the PPDU frame format may be configured to provide a technical solution to support low latency, to support deterministic latency, and/or to support improved reliability of wireless communications, e.g., as described below.

In some demonstrative aspects, the PPDU frame format may be configured to provide a technical solution to support low latency small packet applications, for example, in wireless networks that are heavily loaded with high throughput transmissions of other clients.

In some demonstrative aspects, the PPDU frame format may be configured to provide a technical solution to improve latency performance of the low latency small packet applications, for example, while minimizing a performance impact on the high throughput transmissions of the other clients, for example, with low overhead cost.

In some demonstrative aspects, controller 124 may be configured to control, trigger, cause, and/or instruct a STA implemented by device 102 to generate a preamble of a PPDU according to a PPDU frame format, e.g., as described below.

In some demonstrative aspects, controller 124 may be configured to control, trigger, cause, and/or instruct the STA implemented by device 102 to generate a data payload of the PPDU according to the PPDU frame format, e.g., as described below.

In some demonstrative aspects, the data payload may include a plurality of data payload portions, e.g., as described below.

In some demonstrative aspects, the PPDU may include a predefined Training Field (TF) between a first data payload portion and a second data payload portion of the plurality of data payload portions, e.g., as described below.

In one example, the PPDU may include the predefined TF between two continuous data payload portions, e.g., between each pair of consecutive first and second data payload portions.

In some demonstrative aspects, controller 124 may be configured to control, trigger, cause, and/or instruct the STA implemented by device 102 to transmit the PPDU, e.g., as described below.

In some demonstrative aspects, device 140 may be configured to receive and process a PPDU, e.g., the PPDU transmitted by device 102, according to the PPDU frame format, e.g., as described below.

In some demonstrative aspects, controller 154 may be configured to control, trigger, cause, and/or instruct a STA implemented by device 140 to process the preamble of the PPDU according to the PPDU frame format, e.g., as described below.

In some demonstrative aspects, controller 154 may be configured to control, trigger, cause, and/or instruct the STA implemented by device 140 to process the data payload of the PPDU according to the PPDU frame format, e.g., as described below.

In some demonstrative aspects, the data payload may include the plurality of data payload portions, e.g., as described above.

In some demonstrative aspects, the PPDU may include the predefined TF between the first data payload portion and the second data payload portion of the plurality of data payload portions, e.g., as described above.

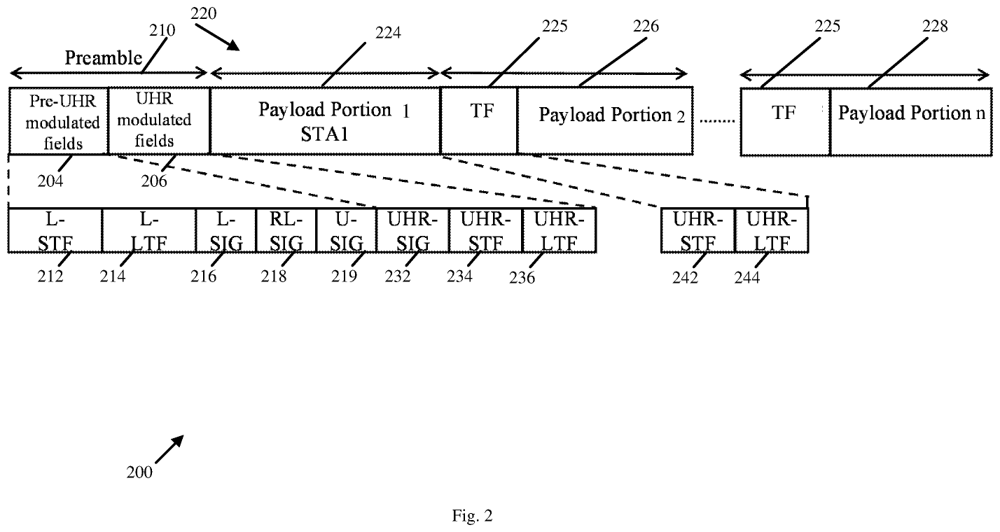

Reference is made to FIG. 2, which schematically illustrates a PPDU frame format 200, in accordance with some demonstrative aspects.

In one example, devices 102 (FIG. 1), 140 (FIG. 1), and/or 160 (FIG. 1) may be configured to generate, transmit, receive, and/or process one or more PPDUs having the structure and/or frame format of PPDU 200.

In some demonstrative aspects, devices 102 (FIG. 1), 140 (FIG. 1), and/or 160 (FIG. 1) may communicate PPDU 200, for example, as part of a transmission between devices 102 (FIG. 1), 140 (FIG. 1), and/or 160 (FIG. 1), e.g., as described below.

In some demonstrative aspects, as shown in FIG. 2, PPDU 200 may include a UHR PPDU, e.g., as described below.

In other aspects, PPDU 200 may be configured as any other type of PPDU, e.g., according to any other suitable PPDU communication scheme and/or mechanism.

In some demonstrative aspects, as shown in FIG. 2, PPDU 200 may include a preamble 210.

In some demonstrative aspects, as shown in FIG. 2, PPDU 200 may include a data payload 220, e.g., after the preamble 210.

In some demonstrative aspects, as shown in FIG. 2, data payload 220 may include a plurality of data payload portions, e.g., as described below.

In some demonstrative aspects, as shown in FIG. 2, PPDU 200 may include a predefined TF 225 between two consecutive data payload portions, e.g., as described below.

In some demonstrative aspects, as shown in FIG. 2, PPDU 200 may include a predefined TF 225 between each two consecutive data payload portions, e.g., as described below.

In some demonstrative aspects, as shown in FIG. 2, PPDU 200 may include the predefined TF 225 prior to each data portion which is not a first-in order data portion, e.g., as described below.

In some demonstrative aspects, as shown in FIG. 2, PPDU 200 may include a predefined TF 225 between a first data payload portion 224 and a second data payload portion 226 of the plurality of data payload portions, e.g., as described below.

In some demonstrative aspects, as shown in FIG. 2, PPDU 200 may include the predefined TF 225 preceding each non-first-in-order data payload portion of the plurality of data payload portions, e.g., as described below.

In one example, as shown in FIG. 2, TF 225 may precede data payload portion 224, data payload portion 226, and/or data payload portion 228.

In some demonstrative aspects, as shown in FIG. 2, PPDU 200 may include a first-in-order data payload portion, e.g., data payload portion 224, followed by one or more non-first-in-order data payload portions, e.g., as described below.

For example, data payload portion 224 may be followed by data payload portions 226 and/or 228.

In some demonstrative aspects, as shown in FIG. 2, PPDU 200 may include one or more predefined TFs 225 preceding the one or more non-first-in-order data payload portions, respectively, e.g., as described below.

For example, TFs 225 may precede data payload portion 226 and/or data payload portion 228.

In some demonstrative aspects, as shown in FIG. 2, preamble 210 may include a non High Throughput (HT) Short Training Field (L-STF) 212, e.g., as described below.

In some demonstrative aspects, the predefined TF 225 may be different from the L-STF 212, e.g., as described below.

In some demonstrative aspects, the predefined TF 225 may be configured to be different from the L-STF 212, for example, to provide a technical solution to differentiate the predefined TF 225 from a legacy preamble, e.g., as described below.

In some demonstrative aspects, the predefined TF 225 may include a UHR TF, e.g., as described below.

In some demonstrative aspects, as shown in FIG. 2, the predefined TF 225 may include a UHR Short TF 242 (UHR-STF), e.g., as described below.

In some demonstrative aspects, as shown in FIG. 2, the predefined TF 225 may include a UHR Long TF (UHR-LTF) 244, for example, after UHR-STF 242 or instead of UHR-STF 242, e.g., as described below.

In other aspects, the predefined TF 225 may include any other additional or alternative type of training field.

In some demonstrative aspects, as shown in FIG. 2, preamble 210 may include a plurality of pre-UHR modulated fields 204 followed by a plurality of UHR modulated fields 206, e.g., as described below.

In some demonstrative aspects, as shown in FIG. 2, the plurality of pre-UHR modulated fields 204 may include the L-STF 212, e.g., as described below.

In some demonstrative aspects, as shown in FIG. 2, the plurality of pre-UHR modulated fields 204 may include a non-HT Long Training Field (L-LTF) 214, for example, after the L-STF 212, e.g., as described below.

In some demonstrative aspects, as shown in FIG. 2, the plurality of pre-UHR modulated fields 204 may include a non-HT Signal (L-SIG) field 216, for example, after the L-LTF 214, e.g., as described below.

In some demonstrative aspects, as shown in FIG. 2, the plurality of pre-UHR modulated fields 204 may include a Repeated L-SIG (RL-SIG) field 218, for example, after the L-SIG field 216, e.g., as described below.

In some demonstrative aspects, as shown in FIG. 2, the plurality of pre-UHR modulated fields 204 may include a Universal SIG (U-SIG) field 219, for example, after the RL-SIG field 218, e.g., as described below.

In some demonstrative aspects, the U-SIG field 219 may include a frame format indication field, for example, to indicate the PPDU frame format of PPDU 200, e.g., as described below.

In one example, the U-SIG field 219 may include two or four OFDM symbols. For example, an operation range may be extended, for example, when the U-SIG field 219 includes four OFDM symbols.

In other aspects, U-SIG field 219 may be configured to include any other count of OFDM symbols.

In other aspects, the plurality of pre-UHR modulated fields 204 may include any other additional and/or alternative fields.

In some demonstrative aspects, as shown in FIG. 2, the plurality of UHR modulated fields 206 may include a UHR Signal (UHR-SIG) field 232, e.g., as described below.

In some demonstrative aspects, as shown in FIG. 2, the plurality of UHR modulated fields 206 may include a UHR Short Training Field (UHR-STF) 234, for example, after the UHR-SIG field 232, e.g., as described below.

In some demonstrative aspects, as shown in FIG. 2, the plurality of UHR modulated fields 206 may include a UHR Long Training Field (UHR-LTF) 236, for example, after the UHR-STF 234, e.g., as described below.

In other aspects, the plurality of UHR modulated fields 206 may include any other additional and/or alternative fields.

In some demonstrative aspects, the PPDU 200 may configured, for example, such that all of the plurality of data payload portions are for a same STA, e.g., as described below.

In some demonstrative aspects, the PPDU 200 may configured, for example, such that the plurality of data payload portions are for a plurality of STAs, e.g., as described below.

In some demonstrative aspects, the PPDU 200 may include one or more first-STA data payload portions for a first STA, and one or more second-STA data payload portions for a second STA, for example, after the one or more first-STA data payload portions, e.g., as described below.

In some demonstrative aspects, the PPDU 200 may include another preamble, e.g., a full preamble, between the one or more first-STA data payload portions and the one or more second-STA data payload portions, e.g., as described below.

In one example, the PPDU 200 may be configured to include a full preamble, e.g., including some or all of the fields of preamble 210, for example, prior to a data payload portion for the second STA. For example, the PPDU 200 may be configured to include the preamble for the second STA, e.g., prior to a first-in-order data payload portion for the second STA, e.g., as described below.

In some demonstrative aspects, the PPDU 200 may include a Short-Inter-Frame-Space (SIFS) or a Point Coordination Function (PCF) Inter-Frame-Space (PIFS) between the first data payload portion 224 and the predefined TF 225 prior to the second data payload portion 226, e.g., as described below.

In one example, the PPDU 200 may include the SIFS or the PIFS between two continuous data payload portions, e.g., between each pair of consecutive data payload portions.

In other aspects, the PPDU 200 may include any other predefined duration between the first data payload portion 224 and the predefined TF 225 prior to the second data payload portion 226.

Referring back to FIG. 1, in some demonstrative aspects, device 102, device 140, and/or device 160 may be configured to communicate a PPDU including an A-PSDU according to an A-PSDU frame format, e.g., as described below.

In some demonstrative aspects, device 102, device 140, and/or device 160 may be configured to generate, transmit, receive, and/or process the A-PSDU according to the A-PSDU frame format, e.g., as described below.

In some demonstrative aspects, controller 124 may be configured to control, trigger, cause, and/or instruct device 102 to transmit the A-PSDU according to the A-PSDU frame format, e.g., as described below.

In some demonstrative aspects, controller 154 may be configured to control, trigger, cause, and/or instruct device 140 to process the A-PSDU according to the A-PSDU frame format, e.g., as described below.

In some demonstrative aspects, controller 124 may be configured to control, trigger, cause, and/or instruct the STA implemented by device 102 to generate a preamble of an A-PSDU according to an A-PSDU frame format, e.g., as described below.

In some demonstrative aspects, controller 124 may be configured to control, trigger, cause, and/or instruct the STA implemented by device 102 to generate a data payload of the A-PSDU according to the A-PSDU frame format, e.g., as described below.

In some demonstrative aspects, the preamble of the A-PSDU may include a frame format indication field configured to indicate that the PPDU is configured according to the A-PSDU frame format, e.g., as described below.

In some demonstrative aspects, the data payload of the A-PSDU may include a plurality of data payload portions, e.g., as described below.

In some demonstrative aspects, the plurality of data payload portions of the A-PSDU may include a plurality of PSDUs, e.g., as described below.

In some demonstrative aspects, the A-PSDU may include a predefined TF between a first PSDU and a second PSDU of the plurality of PSDUs, e.g., as described below.

In some demonstrative aspects, the A-PSDU may include the predefined TF between each two consecutive data payload portions, e.g., as described below.

In some demonstrative aspects, the A-PSDU may include the predefined TF prior to each data portion which is not a first-in order data portion, e.g., as described below.

In some demonstrative aspects, the A-PSDU may include a PSDU header between the first PSDU and the second PSDU of the plurality of PSDUs, e.g., as described below.

In some demonstrative aspects, the A-PSDU may include the PSDU header between each two consecutive data payload portions, e.g., as described below.

In some demonstrative aspects, the A-PSDU may include the PSDU header prior to each data portion which is not a first-in order data portion, e.g., as described below.

In one example, the PSDU header may be before each non-first PSDU of the plurality of PSDUs.

In another example, the PSDU header may be before each non-first PSDU of a plurality of PSDUs to a same receiver or a same group of receivers.

In some demonstrative aspects, the PSDU header may include the predefined TF, e.g., as described below.

In some demonstrative aspects, the TF may be configured to be different from a legacy STF, e.g., the L-STF, for example, to provide a technical solution to differentiate the TF from the legacy STF.

In some demonstrative aspects, the predefined TF may include an STF, e.g., as described below.

In some demonstrative aspects, the PSDU header may include an LTF, for example, after the STF, e.g., as described below.

In some demonstrative aspects, the PSDU header may include a SIG field, for example, after the predefined TF, e.g., as described below.

In some demonstrative aspects, the SIG field may include one or more fields to indicate one or more attributes, parameters and/or settings corresponding to the second PSDU, e.g., as described below.

In some demonstrative aspects, the SIG field in a PSDU header corresponding to a PSDU may include one or more fields to indicate one or more attributes, parameters and/or settings corresponding to a following PSDU, e.g., as described below.

In some demonstrative aspects, the SIG field may include a length field to indicate a length of the second PSDU, e.g., as described below.

In one example, the length field in a PSDU header corresponding to a PSDU may indicate a length of a following PSDU, e.g., as described below.

In some demonstrative aspects, the SIG field may include a Modulation and Coding Scheme (MCS) field to indicate an MCS of the second PSDU, e.g., as described below.

In some demonstrative aspects, the SIG field may include a last-PSDU indication field, for example, to indicate whether or not the second PSDU, e.g., the following PPDU, is a last PSDU in the A-PSDU, e.g., as described below.

In some demonstrative aspects, the SIG field may include a Light SIG (Li-SIG) field, e.g., as described below.

In some demonstrative aspects, the Li-SIG field may be shorter than a SIG field in the preamble of the PPDU, e.g., as described below.

In some demonstrative aspects, the A-PSDU may be configured such that all PSDUs in the A-PSDU are for a same STA, e.g., as described below.

In some demonstrative aspects, the A-PSDU may be configured such that the plurality of PSDUs in the A-PSDU are for a plurality of STAs, e.g., as described below.

In some demonstrative aspects, the A-PSDU may include one or more first-STA PSDUs for a first STA, and one or more second-STA PSDUs for a second STA, for example, after the one or more first-STA PSDUs, e.g., as describe below.

In some demonstrative aspects, the A-PSDU may include another preamble, e.g., a full preamble, between the one or more first-STA PSDUs and the one or more second-STA PSDUs, e.g., as describe below.

For example, A-PSDU may be configured to include a full preamble, e.g., including some or all of the fields of the preamble at the beginning of the A-PSDU, for example, prior to a PSDU for the second STA. For example, the A-PSDU may be configured to include the preamble for the second STA, e.g., prior to a first-in-order PSDU for the second STA, e.g., as described below.

In some demonstrative aspects, the A-PSDU frame format may include a SIFS or a PIFS between the first PSDU and the PSDU header prior to the second PSDU, e.g., as describe below.

In one example, the A-PSDU frame format may include the SIFS or the PIFS between two continuous PSDUs, e.g., between each pair of consecutive PSDUs.

In other aspects, the A-PSDU frame format may include any other predefined duration between the first PSDU and the PSDU header prior to the second PSDU.

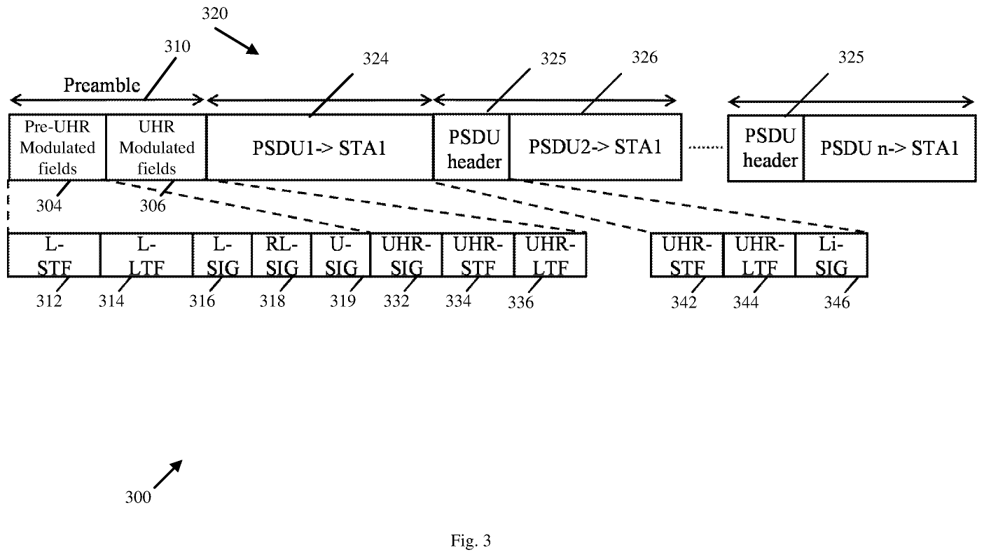

Reference is made to FIG. 3, which schematically illustrates an A-PSDU frame format 300, in accordance with some demonstrative aspects.

In one example, devices 102 (FIG. 1), 140 (FIG. 1), and/or 160 (FIG. 1) may be configured to generate, transmit, receive, and/or process one or more A-PSDUs having the structure and/or format of A-PSDU 300.

In some demonstrative aspects, devices 102 (FIG. 1), 140 (FIG. 1), and/or 160 (FIG. 1) may communicate A-PSDU 300, for example, as part of a transmission between devices 102 (FIG. 1), 140 (FIG. 1), and/or 160 (FIG. 1), e.g., as described below.

In some demonstrative aspects, PPDU 200 (FIG. 2) may be configured to include one or more fields of A-PSDU 300.

In some demonstrative aspects, as shown in FIG. 3, A-PSDU 300 may include a UHR A-PSDU.

In other aspects, A-PSDU 300 may be configured according to any other suitable PHY version and/or technology.

In some demonstrative aspects, as shown in FIG. 3, A-PSDU 300 may include a preamble 310.

In some demonstrative aspects, as shown in FIG. 3, A-PSDU 300 may include a data payload 320.

In some demonstrative aspects, as shown in FIG. 3, data payload 320 may include a plurality of PSDUs.

In some demonstrative aspects, as shown in FIG. 3, A-PSDU 300 may include a PSDU header 325, for example, between a first PSDU 324 and a second PSDU 326 of the plurality of PSDUs.

In some demonstrative aspects, as shown in FIG. 3, preamble 310 may include a full PHY preamble 310, which may be inserted before a first-in-order PSDU, e.g., the first PSDU 324.

In some demonstrative aspects, as shown in FIG. 3, preamble 310 may include a plurality of pre-UHR modulated fields 304 followed by a plurality of UHR modulated fields 306, e.g., as described below.

In some demonstrative aspects, as shown in FIG. 3, the plurality of pre-UHR modulated fields 304 may include an L-STF 312.

In some demonstrative aspects, as shown in FIG. 3, the plurality of pre-UHR modulated fields 304 may include an L-LTF 314, for example, after the STF 312.

In some demonstrative aspects, as shown in FIG. 3, the plurality of pre-UHR modulated fields 304 may include an L-SIG field 316, for example, after the L-LTF 314.

In some demonstrative aspects, a length field in the L-SIG field 316 may be configured to indicate a length to an end of the A-PSDU 300, for example, for a Network Allocation Vector (NAV) setting of legacy devices.

In some demonstrative aspects, as shown in FIG. 3, the plurality of pre-UHR modulated fields 304 may include an RL-SIG field 318, for example, after the L-SIG field 316.

In some demonstrative aspects, as shown in FIG. 3, the plurality of pre-UHR modulated fields 304 may include a U-SIG field 319, for example, after the RL-SIG field 318.

In some demonstrative aspects, the U-SIG field 319 may include a frame format indication field, for example, to indicate the A-PSDU frame format 300, e.g., as described below.

For example, the U-SIG field 319 may be configured to indicate whether the A-PSDU frame format is used or not.

In other aspects, the plurality of pre-UHR modulated fields 304 may include any other additional and/or alternative fields.

In some demonstrative aspects, as shown in FIG. 3, the plurality of UHR modulated fields 306 may include a UHR-SIG field 332.

In some demonstrative aspects, as shown in FIG. 3, the plurality of UHR modulated fields 306 may include a UHR-STF 334, for example, after the UHR-SIG field 332.

In some demonstrative aspects, as shown in FIG. 3, the plurality of UHR modulated fields 306 may include a UHR-LTF 336, for example, after the UHR-STF 334.

In some demonstrative aspects, the UHR-SIG field 332 may be configured to indicate one or more attributes, parameters and/or settings corresponding to the data payload 320, e.g., as described below.

In some demonstrative aspects, the UHR-SIG field 332 may be configured to indicate a data rate of the A-PSDU 300, a length of a following PSDU, e.g., PSDU 324, an Association ID (AID) of a receiver of A-PSDU 300, a number of UHR-LTF 326, a guard interval (GI) size, an LTF size, an indication whether beamforming is used or not in the following PSDUs, and/or any other suitable additional or alternative information.

In other aspects, the plurality of UHR modulated fields 306 may include any other additional and/or alternative fields.

In some demonstrative aspects, as shown in FIG. 3, the PSDU header 325 may include a UHR PSDU header, e.g., as described below.

In other aspects, the PSDU header 325 may be configured according to any other suitable PHY version and/or technology.

In some demonstrative aspects, as shown in FIG. 3, the PSDU header 325 may include a UHR-STF 342.

In some demonstrative aspects, as shown in FIG. 3, the PSDU header 325 may include a UHR-LTF 344, for example, after the UHR-STF 342.

In some demonstrative aspects, as shown in FIG. 3, the PSDU header 325 may include a Li-SIG field 346, for example, after the UHR-LTF 344.

In some demonstrative aspects, the UHR-STF 342 may be configured to indicate a start of a new PSDU, for example, the PSDU 326, e.g., to a same receiver.

In some demonstrative aspects, the UHR-STF 342 and/or the UHR-LTF 344 may be used by a third party device, which is not the receiver of a current PSDU, for example, to decode the Li-SIG field 346, for example, to get length information of a following PSDU.

For example, the third party device may utilize the length information of the following PSDU, for example, to go to a sleep mode, for example, until an end of the following PSDU.

In some demonstrative aspects, the UHR-LTF 344 may be different from the UHR-LTF 336 in the UHR modulated fields 306.

In some demonstrative aspects, the UHR-STF 342 and/or the UHR-LTF 344 may optionally be excluded from the PSDU header 325, for example, in implementations where a third-party device is able to decode the Li-SIG field 346, for example, with an oscillator on.

In some demonstrative aspects, Li-SIG field 346 may be shorter than a SIG field in the preamble 310, e.g., U-SIG 319.

In some demonstrative aspects, the Li-SIG field 346 may include MCS information of a transmitter of A-PSDU 300, for example, to enable a receiver of A-PSDU 300 to adjust one or more MCS settings, e.g., if needed.

In some demonstrative aspects, as shown in FIG. 3, the plurality of PSDUs of A-PSDU 300 may be for a same STA, e.g., “STA1”, or for a same group of STAs, and/or the plurality of PSDUs of A-PSDU 300 may be transmitted with the same transmission parameters.

In other aspects, an A-PSDU frame format may be configured to support PSDUs for a plurality of STAs and/or a plurality of groups of STAs, and/or PSDUs to be transmitted with different transmission parameters, e.g., as described below.

In some demonstrative aspects, an A-PSDU frame format may be configured to include one or more first-STA PSDUs for a first STA or a first group of STAs, and one or more second-STA PSDUs for a second STA or a second group of STAs, for example, after the one or more first-STA PSDUs, e.g., as described below.

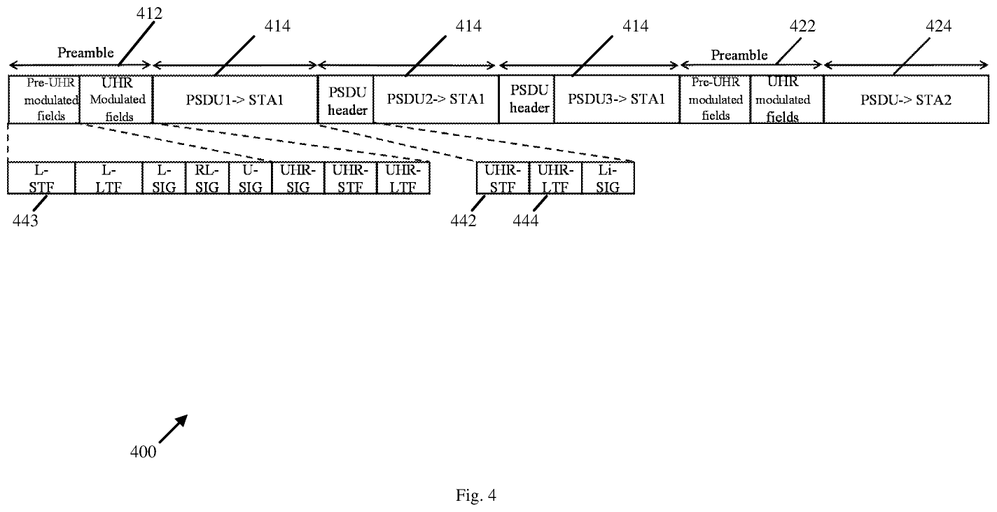

Reference is made to FIG. 4, which schematically illustrates an A-PSDU frame format 400, in accordance with some demonstrative aspects.

In one example, devices 102 (FIG. 1), 140 (FIG. 1), and/or 160 (FIG. 1) may be configured to generate, transmit, receive, and/or process one or more A-PSDUs having the structure and/or frame format of A-PSDU 400.

In some demonstrative aspects, devices 102 (FIG. 1), 140 (FIG. 1), and/or 160 (FIG. 1) may communicate A-PSDU 400, for example, as part of a transmission between devices 102 (FIG. 1), 140 (FIG. 1), and/or 160 (FIG. 1), e.g., as described below.

In some demonstrative aspects, one or more fields of A-PSDU 400 may include one or more fields of A-PSDU 300 (FIG. 3).

In some demonstrative aspects, as shown in FIG. 4, A-PSDU 400 may include a UHR A-PSDU.

In other aspects, A-PSDU 400 may be configured according to any other suitable PHY version and/or technology.

In one example, a STA, e.g., a STA implemented by device 102 (FIG. 1), may utilize A-PSDU 400, for example, to transmit PSDUs to two or more STAs, or to two or more group of STAs.

In another example, a STA, e.g., a STA implemented by device 102 (FIG. 1), may utilize A-PSDU 400, for example, when the STA is going to change one or more transmission parameters, e.g., a number of spatial streams and/or the like, between transmissions of PSDUs to a same device or to a same group of devices.

In some demonstrative aspects, as shown in FIG. 4, a first preamble 412 for the one or more first-STA PSDUs 414 may be included as part of a first preamble 412 of A-PSDU 400.

In some demonstrative aspects, as shown in FIG. 4, the first preamble 412 may be before the one or more first-STA PSDUs 414 for the first STA.

In some demonstrative aspects, as shown in FIG. 4, A-PSDU 400 may include one or more second-STA PSDUs 424 for a second STA, and a second preamble 422 for the one or more second-STA PSDUs 424.

In some demonstrative aspects, as shown in FIG. 4, second preamble 422 may be between the one or more first-STA PSDUs 414 and the one or more second-STA PSDUs 424.

In some demonstrative aspects, the second preamble 422 may include a full preamble, e.g., including all fields of the preamble 412.

In some demonstrative aspects, a UHR-STF, e.g., a UHR-STF 442, which may be in a PSDU header, or an L-STF, e.g., which may be in a preamble, for example, after a first PSDU, e.g., preamble 422, may be used to identify whether a following PSDU is for the same device or the same group of devices with the same, e.g., significantly the same, or no much change of, transmission parameters.

In some demonstrative aspects, for example, upon detection of the UHR-STF after the current PSDU, a receiver of the current PSDU may read and interpret the UHR-STF to identify that the transmitter is going to send a next PSDU to the receiver.

In some demonstrative aspects, the receiver of the current PSDU may need to save Channel State Information (CSI), for example, based on the UHR-LTFs within the full preamble, e.g., when beamforming is used.

In some demonstrative aspects, as shown in FIG. 4, the transmitter of A-PSDU 400 may add a full preamble, e.g., preamble 422, before a following PSDU, for example, when the transmitter of A-PSDU 400 is going to transmit a PSDU to another device, or to another group of devices, or when the transmitter is going to change one or more transmission parameters, such as number of spatial streams and/or the like, e.g., to a same device or to a same group of devices.

In some demonstrative aspects, the transmitter may add another full preamble, for example, when the same situation happens with another device, or another group of devices.

In some demonstrative aspects, A-PSDU frame format 300 (FIG. 3) and/or A-PSDU frame format 400 may be extended, for example, to provide a technical solution to support a predefined time gap, e.g., a SIFS or a PIFS, between two continuous PSDUs, e.g., as described below.

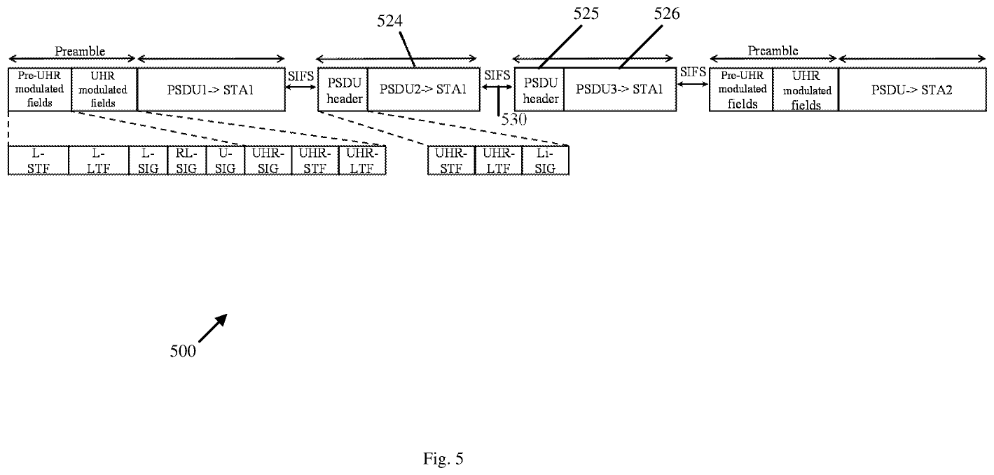

Reference is made to FIG. 5, which schematically illustrates an A-PSDU frame format 500, in accordance with some demonstrative aspects.

In one example, devices 102 (FIG. 1), 140 (FIG. 1), and/or 160 (FIG. 1) may be configured to generate, transmit, receive, and/or process one or more A-PSDUs having the structure and/or frame format of A-PSDU 500.

In some demonstrative aspects, devices 102 (FIG. 1), 140 (FIG. 1), and/or 160 (FIG. 1) may communicate A-PSDU 500, for example, as part of a transmission between devices 102 (FIG. 1), 140 (FIG. 1), and/or 160 (FIG. 1), e.g., as described below.

In some demonstrative aspects, one or more fields of A-PSDU 500 may include one or more fields of A-PSDU 300 (FIG. 3), and/or A-PSDU 400 (FIG. 4).

In some demonstrative aspects, as shown in FIG. 5, A-PSDU 500 may include a UHR A-PSDU.

In other aspects, A-PSDU 500 may be configured according to any other suitable PHY version and/or technology.

In some demonstrative aspects, as shown in FIG. 5, the A-PSDU frame format 500 may include a SIFS 530 between two consecutive PSDUs.

In some demonstrative aspects, as shown in FIG. 5, the A-PSDU frame format 500 may include a SIFS 530 between each two consecutive PSDUs.

In other aspects, the A-PSDU frame format 500 may include a SIFS 530 between only some of the PSDUs.

In some demonstrative aspects, as shown in FIG. 5, the A-PSDU frame format 500 may include a SIFS 530 between a first PSDU 524 and a PSDU header 525 prior to a second PSDU 526.

In some demonstrative aspects, as shown in FIG. 5, A-PSDU frame format 500 may extend the A-PSDU frame format 300 (FIG. 3) and/or the A-PSDU frame format 400 (FIG. 4), for example, to add a fixed time gap, e.g., SIFS 530 or a PIFS, for example, between two continuous PSDUs, e.g., between the PSDU 524 and the PSDU header 525 prior to the PSDU 526.

In some demonstrative aspects, A-PSDU frame format 500 may be configured to include the fixed time gap between PSDUs, for example, to provide a technical solution to support preemption for low latency applications.

In some demonstrative aspects, a transmitter of the A-PSDU 500 may check during the fixed time gap, e.g., SIFS 530, whether or not another device has sent a signal to grab the channel, e.g., for a low latency transmission.

Referring back to FIG. 1, in some demonstrative aspects, device 102, device 140, and/or device 160 may be configured to communicate a PPDU including a fragmented PPDU according to a fragmented PPDU frame format, e.g., as described below.

In some demonstrative aspects, device 102, device 140, and/or device 160 may be configured to generate, transmit, receive, and/or process the fragmented PPDU according to the fragmented PPDU frame format, e.g., as described below.

In some demonstrative aspects, controller 124 may be configured to control, trigger, cause, and/or instruct device 102 to transmit the fragmented PPDU according to the fragmented PPDU frame format, e.g., as described below.

In some demonstrative aspects, controller 154 may be configured to control, trigger, cause, and/or instruct device 140 to process the fragmented PPDU according to the fragmented PPDU frame format, e.g., as described below.

In some demonstrative aspects, controller 124 may be configured to control, trigger, cause, and/or instruct the STA implemented by device 102 to generate a preamble of a fragmented PPDU according to a fragmented PPDU frame format, e.g., as described below.

In some demonstrative aspects, controller 124 may be configured to control, trigger, cause, and/or instruct the STA implemented by device 102 to generate a data payload of the fragmented PPDU according to the fragmented PPDU frame format, e.g., as described below.

In some demonstrative aspects, the data payload of the fragmented PPDU may include a plurality of data payload portions, e.g., as described below.

In some demonstrative aspects, the plurality of data payload portions of the fragmented PPDU may include a plurality of PPDU fragments, e.g., as described below.

In some demonstrative aspects, the fragmented PPDU may include a predefined TF between a first PPDU fragment and a second PPDU fragment of the plurality of PPDU fragments, e.g., as described below.

For example, the predefined TF may be inserted between two continuous PPDU fragments, e.g., between each two consecutive PPDU fragments.

In some demonstrative aspects, the predefined TF may include an STF, or an LTF, e.g., as described below.

In one example, the STF of the predefined TF may be different from a legacy STF, e.g., the L-STF, for example, to differentiate the predefined TF from a normal legacy preamble.

In some demonstrative aspects, the preamble of the fragmented PPDU may include a frame format indication field configured to indicate that the PPDU is configured according to the fragmented PPDU frame format, e.g., as described below.

In some demonstrative aspects, the preamble of the fragmented PPDU may include a duration field to indicate a length of a fixed fragment duration for the fragmented PPDU, e.g., as described below.

In some demonstrative aspects, the fragmented PPDU frame format may include a fixed fragmentation duration for a plurality of PPDU portions corresponding to the plurality of PPDU fragments, e.g., as described below.

In some demonstrative aspects, a duration of a first-in-order PPDU portion of the fragmented PPDU may be equal to a duration of a non-first-in-order PPDU portion of the fragmented PPDU, e.g., as described below.

In some demonstrative aspects, the first-in-order PPDU portion may include the preamble of the fragmented PPDU and a first-in-order PPDU fragment of the plurality of PPDU fragments, e.g., as described below.

In some demonstrative aspects, the non-first-in-order PPDU portion may include the predefined TF and a non-first-in-order PPDU fragment of the plurality of PPDU fragments, e.g., as described below.

In some demonstrative aspects, the fragmented PPDU may include one or more first-STA PPDU fragments for a first STA, and one or more second-STA PPDU fragments for a second STA, for example, after the one or more first-STA PPDU fragments, e.g., as described below.

In some demonstrative aspects, the fragmented PPDU may include another preamble, e.g., a full preamble, between the one or more first-STA PPDU fragments and the one or more second-STA PPDU fragments, e.g., as described below.

In some demonstrative aspects, the fragmented PPDU frame format may include a SIFS or a PIFS between the first PPDU frame fragment and the predefined TF prior to the second PPDU fragment, e.g., as described below.

In one example, the fragmented PPDU frame format may include the SIFS or the PIFS, for example, between two continuous PPDU frame fragments, e.g., between each two consecutive PPDU fragments, e.g., as described below.

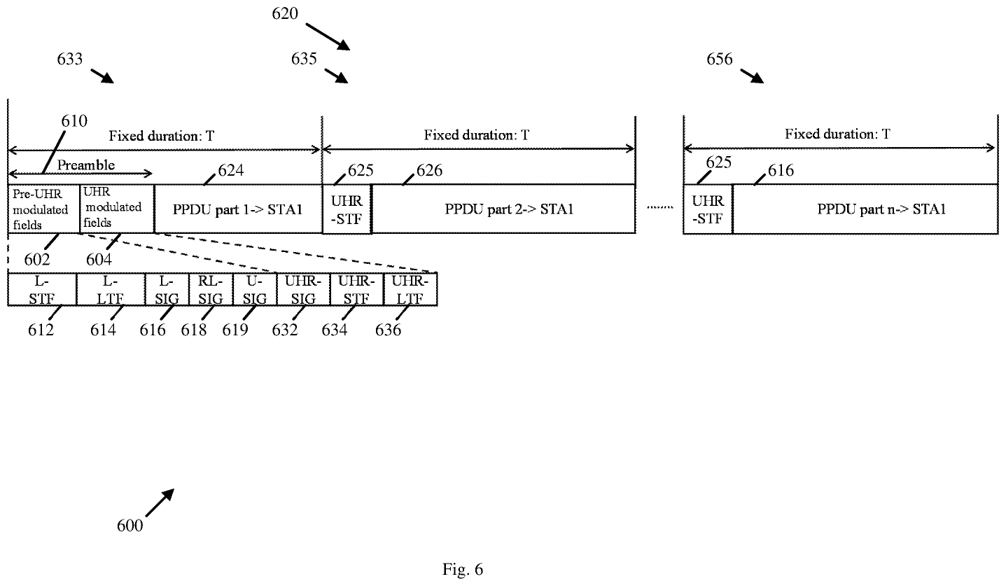

Reference is made to FIG. 6, which schematically illustrates a fragmented PPDU format 600, in accordance with some demonstrative aspects.

In one example, devices 102 (FIG. 1), 140 (FIG. 1), and/or 160 (FIG. 1) may be configured to generate, transmit, receive, and/or process one or more fragmented PPDUs having the structure and/or frame format of fragmented PPDU 600.

In some demonstrative aspects, devices 102 (FIG. 1), 140 (FIG. 1), and/or 160 (FIG. 1) may communicate fragmented PPDU 600, for example, as part of a transmission between devices 102 (FIG. 1), 140 (FIG. 1), and/or 160 (FIG. 1), e.g., as described below.

In some demonstrative aspects, PPDU 200 (FIG. 2) may include one or more fields of fragmented PPDU 600.

In some demonstrative aspects, as shown in FIG. 6, fragmented PPDU 600 may include a UHR fragmented PPDU.

In other aspects, fragmented PPDU 600 may be configured according to any other suitable PHY version and/or technology.

In some demonstrative aspects, as shown in FIG. 6, fragmented PPDU 600 may include a preamble 610.

In some demonstrative aspects, as shown in FIG. 6, preamble 610 may include a full PHY preamble.

In some demonstrative aspects, as shown in FIG. 6, preamble 610 may include a plurality of pre-UHR modulated fields 604, which may be followed, for example, by a plurality of UHR modulated fields 606, e.g., as described below.

In some demonstrative aspects, as shown in FIG. 6, fragmented PPDU 600 may include a data payload 620, e.g., after the preamble 610.

In some demonstrative aspects, as shown in FIG. 6, data payload 620 may include a plurality of PPDU fragments.

In some demonstrative aspects, as shown in FIG. 6, fragmented PPDU 600 may include a predefined TF 625 between a first PPDU fragment 624 and a second PPDU fragment 626 of the plurality of PPDU fragments.

In some demonstrative aspects, as shown in FIG. 6, fragmented PPDU 600 may include the predefined TF 625, for example, between each two consecutive PPDU fragments, e.g., for a same STA or group of STAs and/or a same setting of transmission parameters.

In some demonstrative aspects, as shown in FIG. 6, TF 625 may include a UHR-STF.

In other aspects, TF 625 may include any other STF, e.g., according to any other PHY version and/or technology.

In some demonstrative aspects, as shown in FIG. 6, fragmented PPDU 600 may include a fixed fragmentation duration, denoted T, for a plurality of PPDU portions corresponding to the plurality of PPDU fragments.

In some demonstrative aspects, as shown in FIG. 6, a duration, e.g., the duration T, of a first-in-order PPDU portion 633 of the fragmented PPDU 600 may be equal to a duration, e.g., the duration T, of a non-first-in-order PPDU portion 635 of the fragmented PPDU 600.

In some demonstrative aspects, as shown in FIG. 6, the first-in-order PPDU portion 633 may include the preamble 610 of the PPDU and a first-in-order PPDU fragment of the plurality of PPDU fragments, e.g., the PPDU fragment 624.

In some demonstrative aspects, as shown in FIG. 6, the non-first-in-order PPDU portion 635 may include the predefined TF 625 and a non-first-in-order PPDU fragment of the plurality of PPDU fragments, e.g., the PPDU fragment 626.

In some demonstrative aspects, as shown in FIG. 6, fragmented PPDU 600 may be divided into the plurality of PPDU fragments, for example, with TF 625 inserted at a beginning of a PPDU fragment, e.g., each PPDU fragment within fragmented PPDU 600, for example, for mobility in accordance with an IEEE 802.11 ax Standard.

In some demonstrative aspects, as shown in FIG. 6, fragmented PPDU 600 may be divided into the plurality of PPDU fragments, for example, with UHR-STF 625 inserted at a beginning of a PPDU fragment, e.g., each PPDU fragment within fragmented PPDU 600.

In some demonstrative aspects, fragmented PPDU 600 may be divided into the plurality of PPDU fragments with a UHR-LTF, e.g., an HE-LTF or any other LTF, at the beginning of a PPDU fragment, e.g., each PPDU fragment within fragmented PPDU 600.

In some demonstrative aspects, each PPDU portion, e.g., except from the last PPDU portion, may have the same duration T.

In some demonstrative aspects, a last PPDU portion 656 may have a duration, which may be the same as the duration T, or shorter than the previous duration T.

In some demonstrative aspects, the duration T of the PPDU portions may be preconfigured or defined in a specification and/or standard.

In some demonstrative aspects, the duration T of the PPDU portions may be indicated in fragmented PPDU 600, e.g., as described below.

In one example, the duration T of the PPDU portions may be indicated, for example, in preamble 610, e.g., in UHR modulated fields 606.

In some demonstrative aspects, as shown in FIG. 6, the duration of the first PPDU fragment 624 may be shorter than the duration of second PPDU fragment 626, for example, since use the first PPDU portion 633 may include the pre-UHR modulated fields 604.

In some demonstrative aspects, each PPDU fragment, e.g., except from the last PPDU fragment, may have a same number of data OFDM symbols.

In some demonstrative aspects, each PPDU fragment, e.g., except from the last PPDU fragment, may have the same duration T, for example, to provide a technical solution to support reduced complexity.

In some demonstrative aspects, a last PPDU fragment may have a duration, which may be the same as the duration T, or shorter than the previous duration T.

In some demonstrative aspects, the duration of the first PPDU portion 633 may be longer than the duration of second PPDU portion 635, for example, since use the first PPDU portion 633 may include the pre-UHR modulated fields 604.

In some demonstrative aspects, as shown in FIG. 6, preamble 610, e.g., a full PHY preamble, may be inserted before the first in order PPDU fragment 624, e.g., at the beginning of the fragmented PPDU 600.

In some demonstrative aspects, as shown in FIG. 6, the plurality of pre-UHR modulated fields 604 may include an L-STF 612.

In some demonstrative aspects, as shown in FIG. 6, the plurality of pre-UHR modulated fields 604 may include an L-LTF 614, for example, after the L-STF 612.

In some demonstrative aspects, as shown in FIG. 6, the plurality of pre-UHR modulated fields 604 may include an L-SIG field 616, for example, after the L-LTF 614.

In some demonstrative aspects, a length field in the L-SIG field 616 may be configured to indicate a length to an end of the fragmented PPDU 600, for example, to enable legacy devices to hold transmissions, for example, by setting the NAV.

In some demonstrative aspects, as shown in FIG. 6, the plurality of pre-UHR modulated fields 604 may include an RL-SIG field 618, for example, after the L-SIG field 616.

In some demonstrative aspects, as shown in FIG. 6, the plurality of pre-UHR modulated fields 604 may include a U-SIG field 619, for example, after the RL-SIG field 618.

In other aspects, the plurality of pre-UHR modulated fields 604 may include any other additional and/or alternative fields.

In some demonstrative aspects, as shown in FIG. 6, the plurality of UHR modulated fields 606 may include a UHR-SIG field 632.

In some demonstrative aspects, as shown in FIG. 6, the plurality of UHR modulated fields 606 may include a UHR-STF 634, for example, after the UHR-SIG field 632.

In some demonstrative aspects, as shown in FIG. 6, the plurality of UHR modulated fields 606 may include a UHR-LTF 636 for example, after the UHR-STF 634.

In other aspects, the plurality of UHR modulated fields 606 may include any other additional and/or alternative fields.

In some demonstrative aspects, the U-SIG field 619 and/or the UHR-SIG field 632 may include an indication, e.g., using one bit or a field, to indicate whether or not a fragmented PPDU frame format is used.

In some demonstrative aspects, the U-SIG field 619 and/or the UHR-SIG field 632 may include a length indication, e.g., using one or more bits or a field, for example, to indicate a length of each PPDU fragment, e.g., the fragment duration T.

In some demonstrative aspects, the UHR-SIG field 632 may include one or more subfields, which may be configured, for example, to indicate a data rate, an AID or STA ID of a receiver of fragmented PPDU 600, and/or one or more parameters of UHR-LTF 626, e.g., a GI size and/or an LTF size.

In some demonstrative aspects, a UHR-STF, e.g., UHR-STF 625, preceding each PPDU fragment may be configured to indicate a start of the PPDU fragment. For example, the UHR-STF may include an indication of the fragmentation and/or length information of a following PPDU fragment, e.g., each PPDU fragment.

In some demonstrative aspects, the UHR-STF may be configured to provide a technical solution to support a third party device, which is not the intended receiver of a current PPDU fragment, to go to a sleep mode, for example, until a beginning of a next PPDU fragment or an end of the current PPDU fragment.

In some demonstrative aspects, in case the third party device detects another UHR-STF after the third party device wakes up, the third party device may be allowed to go back to the sleep mode, for example, until a beginning of a next PPDU fragment or an end of a current PPDU fragment.

In some demonstrative aspects, in case the third party device detects an L-STF, e.g., L-STF 612, the third party device may continue the detection, for example, to check whether or not the following PPDU fragment is intended for the third party device.

In some demonstrative aspects, the UHR-STF 634 within the UHR modulated fields 606 may be different from the UHR-STFs 625 preceding the PPDU fragments.

In some demonstrative aspects, the UHR-STFs 625 may be configured to be different from the UHR-STF 636, for example, to provide a technical solution to support a receiver to differentiate between the UHR-STFs 625 and the UHR-STF 636.

In some demonstrative aspects, the UHR-STFs 625 preceding the PPDU fragments may be configured to be different from the L-STF 612 within the Pre-UHR modulated fields 604.

In some demonstrative aspects, the UHR-STFs 625 may be configured to be different from the L-STF 612, for example, to provide a technical solution to support a receiver to differentiate between STFs, e.g., between the UHR-STFs 625 and the L-STF 612.

In one example, a period of UHR-STFs 625 may be different from a period of the L-STF 612. For example, the L-STF 612 may have a period of 0.8 microseconds (us), and the UHR-STFs 625 may have a period of 0.6 or any other period different from 0.8 us.

In some demonstrative aspects, the TF 625 preceding the second PPDU fragments 626 and later PPDU fragments may be configured to include a TF which is not a short training field signal.

In some demonstrative aspects, the TF 625 may include a signal different from the L-STF, e.g., instead of the short training field signal.

For example, the TF 625 may include an LTF signal, e.g., instead of the short training field signal.

In some demonstrative aspects, a sequence of long training field symbols, e.g., a mid-amble and/or a UHR-LTF, may be used, for example, instead of a UHR-STF.

In some demonstrative aspects, long training field signals, e.g., a UHR-LTF and/or a mid-amble, may follow the UHR-STF 625, for example, for the second PPDU fragment 624 and the latter PPDU fragments. For example, the long training field signals may be configured to provide a technical solution to enhance channel estimation for demodulating the PPDU fragments.

In some demonstrative aspects, the fragmented PPDU format 600 may be configured to provide a technical solution to reduce overhead and/or to reduce complexity of an A-PSDU according to an A-PSDU frame format including a PSDU header prior to a PSDU.

In one example, a receiver of an A-PSDU may be required to decode the PSDU header, for example, to demodulate a following PSDU and/or to know a sleep time.

Accordingly, the PSDU header in the A-PSDU may be sent in a low data rate, e.g., a single stream MCS 0 or the like, for example, in order to allow an intended receiver and third party receivers to receive the PSDU header.

For example, in case one PSDU header of a particular PSDU in the A-PSDU is missed by a receiver, the receiver may not know when the PSDU ends, and, accordingly, the receiver may have to search for a start of a next PSDU.

For example, these issues may increase an overhead and/or a complexity of implementing the A-PSDU.

In some demonstrative aspects, the fragmented PPDU format 600 may be configured to provide a technical solution to reduce the overhead and/or the complexity of the A-PSDU frame format, for example, by removing the PSDU header.

For example, as shown in FIG. 6, the fragmented PPDU format 600 may not include PSDU headers, and the shorter TF 625 may be used, e.g., instead of the PSDU header.

In some demonstrative aspects, as shown in FIG. 6, the plurality of PPDU fragments of fragmented PPDU frame format 600 may be for a same STA, e.g., “STA1”, or for a same group of STAs, and/or the plurality of PPDU fragments of fragmented PPDU 600 may be transmitted with the same transmission parameters.

In other aspects, a fragmented PPDU frame format may be configured to support PPDU fragments for a plurality of STAs and/or a plurality of groups of STAs, and/or PPDU fragments to be transmitted with different transmission parameters, e.g., as described below.

In some demonstrative aspects, a fragmented PPDU frame format may be configured include one or more first-STA PPDU fragments for one or more first STAs, and one or more second-STA PPDU fragments for one or more second STAs, for example, after the one or more first-STA PPDU fragments, e.g., as described below.

In some demonstrative aspects, the transmitter of a current PPDU fragment may add a full preamble before one or more following PPDU fragments, when the transmitter of the current PPDU fragment is going to transmit the one or more following PPDU fragments to another device or another group of devices, or if the transmitter is going to change the transmission parameters to the same device or to the same group of devices, e.g., as described below.

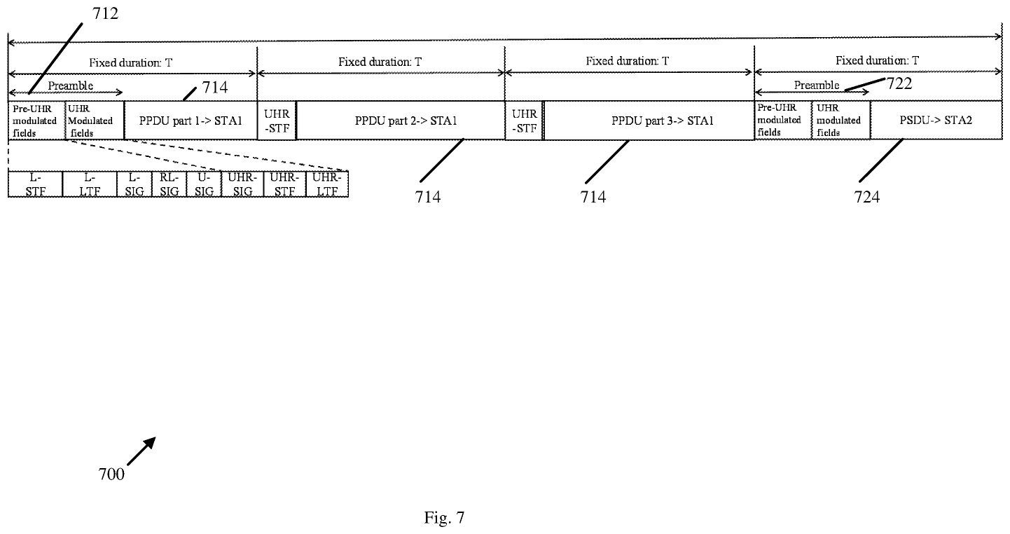

Reference is made to FIG. 7, which schematically illustrates a fragmented PPDU frame format 700, in accordance with some demonstrative aspects.

In one example, devices 102 (FIG. 1), 140 (FIG. 1), and/or 160 (FIG. 1) may be configured to generate, transmit, receive, and/or process one or more fragmented PPDUs having the structure and/or format of fragmented PPDU 700.

In some demonstrative aspects, devices 102 (FIG. 1), 140 (FIG. 1), and/or 160 (FIG. 1) may communicate fragmented PPDU 700, for example, as part of a transmission between devices 102 (FIG. 1), 140 (FIG. 1), and/or 160 (FIG. 1), e.g., as described below.

In some demonstrative aspects, one or more fields of fragmented PPDU 700 may include one or more fields of fragmented PPDU 600 (FIG. 6).

In some demonstrative aspects, as shown in FIG. 7, fragmented PPDU 700 may include a UHR fragmented PPDU.

In other aspects, fragmented PPDU 600 may be configured according to any other suitable PHY version and/or technology.

In one example, a STA, e.g., a STA implemented by device 102 (FIG. 1), may utilize the fragmented PPDU frame format 700, for example, to transmit fragmented PPDU 700 to two or more devices or to two or more groups of devices.

In another example, a STA, e.g., a STA implemented by device 102 (FIG. 1), may utilize fragmented PPDU 700, for example, when the STA is going to change one or more transmission parameters, e.g., a number of spatial streams and/or the like, between transmissions of PPDU fragments to a same device or to a same group of devices.

In some demonstrative aspects, as shown in FIG. 7, a first preamble 712 for the one or more first-STA PPDU fragments 714 may be included as part of a first preamble 712 of fragmented PPDU 700.

In some demonstrative aspects, as shown in FIG. 7, the first preamble 712 may be before the one or more first-STA PPDU fragments 714 for the first STA.

In some demonstrative aspects, as shown in FIG. 7, fragmented PPDU 700 may include one or more second-STA PPDU fragments 724 for a second STA, e.g., STA2, and a second preamble 722 for the one or more second-STA PPDU fragments 724.

In some demonstrative aspects, as shown in FIG. 7, second preamble 722 may be between the one or more first-STA PPDU fragments 714 and the one or more second-STA PPDU fragments 724.

In some demonstrative aspects, the second preamble 722 may include a full preamble, e.g., including all fields of the preamble 712.

In some demonstrative aspects, preamble 722 may be used to identify whether or not a following PPDU fragment may be for a same device or for a same group of devices.

In some demonstrative aspects, another full preamble may be added before PPDU fragments for one or more other devices, for example, when the same situation happens with the other devices.

In some demonstrative aspects, fragmented PPDU frame format 600 (FIG. 6) and/or fragmented PPDU frame format 700 may be extended, for example, to provide a technical solution to support a predefined time gap, e.g., a SIFS or a PIFS, between two continuous PPDU fragments 714, for example, to support preemption for LL applications, e.g., as described below.

In some demonstrative aspects, a fragmented PPDU frame format may include a SIFS or a PIFS between a PPDU fragment 714 and a following PPDU fragment 714, e.g., as described below.

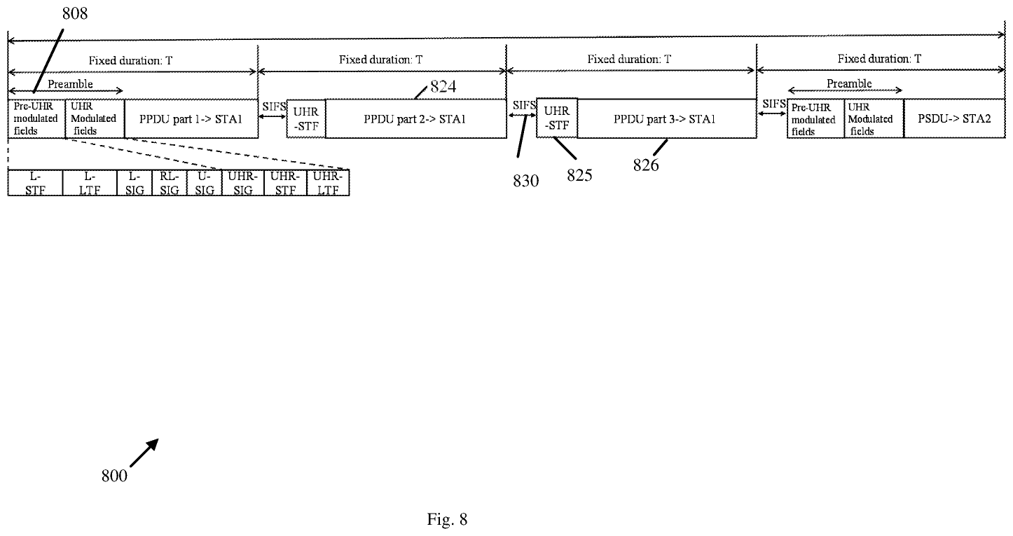

Reference is made to FIG. 8, which schematically illustrates a fragmented PPDU frame format 800, in accordance with some demonstrative aspects.

In one example, devices 102 (FIG. 1), 140 (FIG. 1), and/or 160 (FIG. 1) may be configured to generate, transmit, receive, and/or process one or more fragmented PPDUs having the structure and/or frame format of fragmented PPDU 800.

In some demonstrative aspects, devices 102 (FIG. 1), 140 (FIG. 1), and/or 160 (FIG. 1) may communicate fragmented PPDU 800, for example, as part of a transmission between devices 102 (FIG. 1), 140 (FIG. 1), and/or 160 (FIG. 1), e.g., as described below.

In some demonstrative aspects, one or more fields of fragmented PPDU 800 may include one or more fields of fragmented PPDU 600 (FIG. 6) and/or fragmented PPDU 700 (FIG. 7).

In some demonstrative aspects, as shown in FIG. 8, fragmented PPDU 800 may include a UHR fragmented PPDU.

In other aspects, fragmented PPDU 800 may be configured according to any other suitable PHY version and/or technology.

In some demonstrative aspects, as shown in FIG. 8, the fragmented PPDU frame format 800 may include a SIFS 830 between two consecutive PPDU fragments.

In some demonstrative aspects, as shown in FIG. 8, the fragmented PPDU frame format 800 may include a SIFS 830 between each two consecutive PPDU fragments.

In other aspects, the fragmented PPDU frame format 800 may include a SIFS 830 between only some of the PPDU fragments.

In some demonstrative aspects, as shown in FIG. 8, the fragmented PPDU frame format 800 may include a SIFS 830 between a first PPDU fragment 824 and a TF, e.g., a UHR-STF 825, prior to a second PPDU fragment 826.

In some demonstrative aspects, as shown in FIG. 8, fragmented PPDU frame format 800 may extend the fragmented PPDU frame format 600 (FIG. 6) and/or the fragmented PPDU frame format 700 (FIG. 7), for example, to add a fixed time gap, e.g., SIFS 830 or a PIFS, for example, between two continuous PPDU fragments.

In some demonstrative aspects, fragmented PPDU frame format 800 may be configured to include the fixed time gap between PPDU fragments, for example, to provide a technical solution to support preemption for low latency applications.

In some demonstrative aspects, a transmitter of fragmented PPDU 800 may check during the fixed time gap, e.g., SIFS 830, whether or not another device has sent a signal to grab the channel, e.g., for a low latency transmission.

In some demonstrative aspects, the fixed time gap may not be needed, for example, when preemption is not allowed between two continuous PPDU fragments.

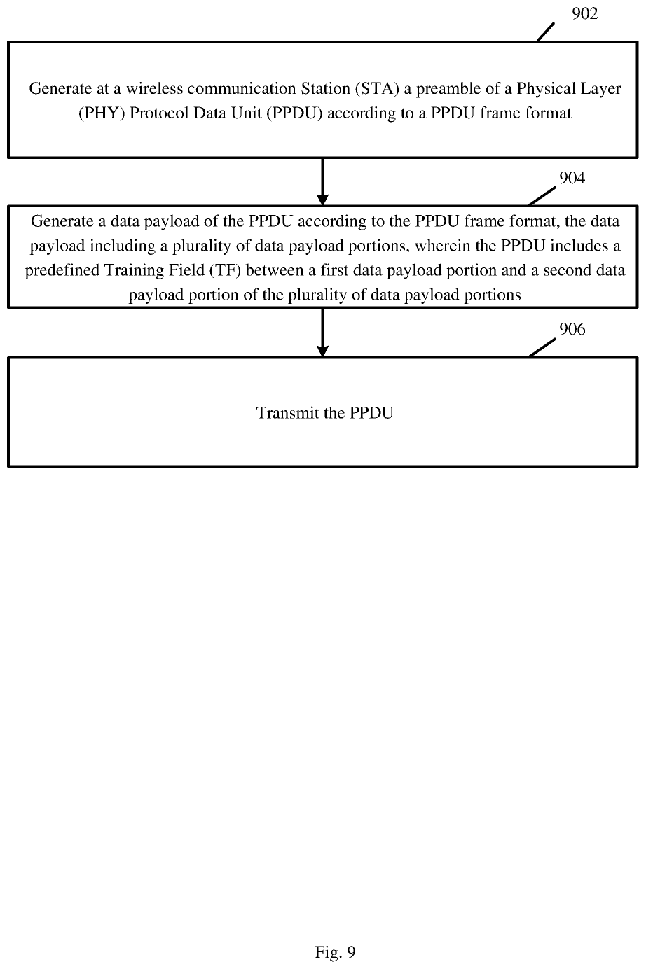

Reference is made to FIG. 9, which schematically illustrates a method of communicating a PPDU, in accordance with some demonstrative aspects. For example, one or more of the operations of the method of FIG. 9 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 902, the method may include generating at a STA a preamble of a PPDU according to a PPDU frame format. For example, controller 124 (FIG. 1) may be configured to cause, trigger, and/or control the STA implemented by device 102 (FIG. 1) to generate the preamble of the PPDU according to the PPDU frame format, e.g., as described above.

As indicated at block 904, the method may include generating a data payload of the PPDU according to the PPDU frame format. For example, the data payload may include a plurality of data payload portions. For example, the PPDU may include a predefined TF between a first data payload portion and a second data payload portion of the plurality of data payload portions. For example, controller 124 (FIG. 1) may be configured to cause, trigger, and/or control the STA implemented by device 102 (FIG. 1) to generate the data payload of the PPDU according to the PPDU frame format, e.g., as described above.

As indicated at block 906, the method may include transmitting the PPDU. For example, controller 124 (FIG. 1) may be configured to cause, trigger, and/or control the STA implemented by device 102 (FIG. 1) to transmit the PPDU, e.g., as described above.

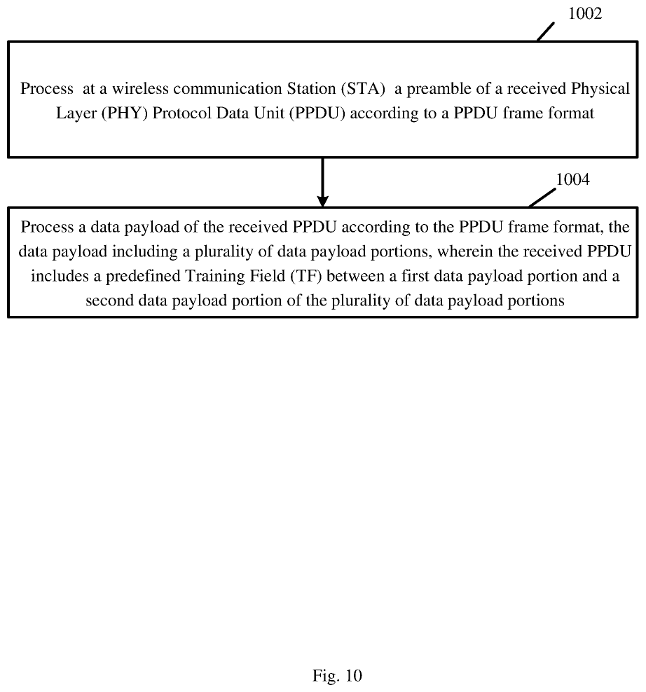

Reference is made to FIG. 10, which schematically illustrates a method of communicating a PPDU, in accordance with some demonstrative aspects. For example, one or more of the operations of the method of FIG. 10 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 1002, the method may include processing at a STA a preamble of a received PPDU according to a PPDU frame format. For example, controller 154 (FIG. 1) may be configured to cause, trigger, and/or control the STA implemented by device 140 (FIG. 1) to process the preamble of the received PPDU according to the PPDU frame format, e.g., as described above.

As indicated at block 1004, the method may include processing a data payload of the received PPDU according to the PPDU frame format. For example, the data payload may include a plurality of data payload portions. For example, the PPDU may include a predefined TF between a first data payload portion and a second data payload portion of the plurality of data payload portions. For example, controller 154 (FIG. 1) may be configured to cause, trigger, and/or control the STA implemented by device 140 (FIG. 1) to process the data payload of the received PPDU according to the PPDU frame format, e.g., as described above.

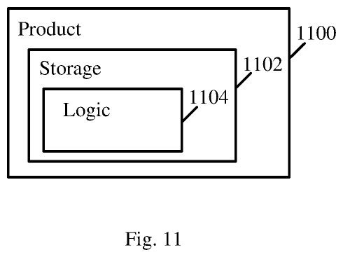

Reference is made to FIG. 11, which schematically illustrates a product of manufacture 1100, in accordance with some demonstrative aspects. Product 1100 may include one or more tangible computer-readable (“machine-readable”) non-transitory storage media 1102, which may include computer-executable instructions, e.g., implemented by logic 1104, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, 7, 8, 9 and 10, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 1100 and/or machine readable storage media 1102 may include one or more types of computer-readable storage media capable of storing data, including volatile memory, non-volatile memory, removable or non-removable memory, erasable or non-erasable memory, writeable or re-writeable memory, and the like. For example, machine readable storage media 1102 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 1104 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1104 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause a wireless communication Station (STA) to generate a preamble of a Physical Layer (PHY) Protocol Data Unit (PPDU) according to a PPDU frame format; generate a data payload of the PPDU according to the PPDU frame format, the data payload comprising a plurality of data payload portions, wherein the PPDU comprises a predefined Training Field (TF) between a first data payload portion and a second data payload portion of the plurality of data payload portions; and transmit the PPDU.

Example 2 includes the subject matter of Example 1, and optionally, wherein the PPDU comprises an Aggregate PHY Service Data Unit (PSDU) (A-PSDU) according to an A-PSDU frame format, wherein the plurality of data payload portions comprises a plurality of PSDUs.

Example 3 includes the subject matter of Example 2, and optionally, wherein the A-PSDU comprises a PSDU header between a first PSDU and a second PSDU of the plurality of PSDUs, wherein the PSDU header comprises the predefined TF.

Example 4 includes the subject matter of Example 3, and optionally, wherein the predefined TF comprises a Short Training Field (STF).

Example 5 includes the subject matter of Example 4, and optionally, wherein the PSDU header comprises a Long Training Field (LTF) after the STF.

Example 6 includes the subject matter of any one of Examples 3-5, and optionally, wherein the PSDU header comprises a Signal (SIG) field after the predefined TF, wherein the SIG field comprises a length field to indicate a length of the second PSDU.

Example 7 includes the subject matter of Example 6, and optionally, wherein the SIG field comprises a Modulation and Coding Scheme (MCS) field to indicate an MCS of the second PSDU.

Example 8 includes the subject matter of Example 6 or 7, and optionally, wherein the SIG field comprises a last-PSDU indication field to indicate whether or not the second PSDU is a last PSDU in the A-PSDU.

Example 9 includes the subject matter of any one of Examples 6-8, and optionally, wherein the SIG field comprises a Light SIG (Li-SIG) field.

Example 10 includes the subject matter of Example 9, and optionally, wherein the Li-SIG field is shorter than a SIG field in the preamble of the PPDU.

Example 11 includes the subject matter of any one of Examples 3-10, and optionally, wherein the A-PSDU frame format comprises a Short-Inter-Frame-Space (SIFS) or a Point Coordination Function (PCF) Inter-Frame-Space (PIFS) between the first PSDU and the PSDU header prior to the second PSDU.

Example 12 includes the subject matter of any one of Examples 2-11, and optionally, wherein the A-PSDU comprises one or more first-STA PSDUs for a first STA, and one or more second-STA PSDUs for a second STA after the one or more first-STA PSDUs, wherein the A-PSDU comprises another preamble between the one or more first-STA PSDUs and the one or more second-STA PSDUs.

Example 13 includes the subject matter of any one of Examples 2-12, and optionally, wherein the preamble comprises a frame format indication field configured to indicate that the PPDU is configured according to the A-PSDU frame format.

Example 14 includes the subject matter of Example 1, and optionally, wherein the PPDU comprises a fragmented PPDU according to a fragmented PPDU frame format, wherein the plurality of data payload portions comprises a plurality of PPDU fragments, wherein the predefined TF is between a first PPDU fragment and a second PPDU fragment.

Example 15 includes the subject matter of Example 14, and optionally, wherein the fragmented PPDU frame format comprises a fixed fragmentation duration for a plurality of PPDU portions corresponding to the plurality of PPDU fragments.

Example 16 includes the subject matter of Example 14 or 15, and optionally, wherein a duration of a first-in-order PPDU portion of the fragmented PPDU is equal to a duration of a non-first-in-order PPDU portion of the fragmented PPDU, wherein the first-in-order PPDU portion comprises the preamble of the PPDU and a first-in-order PPDU fragment of the plurality of PPDU fragments, wherein the non-first-in-order PPDU portion comprises the predefined TF and a non-first-in-order PPDU fragment of the plurality of PPDU fragments.

Example 17 includes the subject matter of any one of Examples 14-16, and optionally, wherein the predefined TF comprises a Short TF (STF) or a Long TF (LTF).

Example 18 includes the subject matter of any one of Examples 14-17, and optionally, wherein the fragmented PPDU comprises one or more first-STA PPDU fragments for a first STA, and one or more second-STA PPDU fragments for a second STA after the one or more first-STA PPDU fragments, wherein the fragmented PPDU comprises another preamble between the one or more first-STA PPDU fragments and the one or more second-STA PPDU fragments.

Example 19 includes the subject matter of any one of Examples 14-18, and optionally, wherein the fragmented PPDU frame format comprises a Short-Inter-Frame-Space (SIFS) or a Point Coordination Function (PCF) Inter-Frame-Space (PIFS) between the first PPDU frame fragment and the predefined TF prior to the second PPDU fragment.

Example 20 includes the subject matter of any one of Examples 14-19, and optionally, wherein the preamble comprises a duration field to indicate a length of a fixed fragment duration for the fragmented PPDU.

Example 21 includes the subject matter of any one of Examples 14-20, and optionally, wherein the preamble comprises a frame format indication field configured to indicate that the PPDU is configured according to the fragmented PPDU frame format.

Example 22 includes the subject matter of any one of Examples 1-21, and optionally, wherein the PPDU comprises the predefined TF preceding each non-first-in-order data payload portion of the plurality of data payload portions.

Example 23 includes the subject matter of any one of Examples 1-22, and optionally, wherein the PPDU comprises a first-in-order data payload portion followed by one or more non-first-in-order data payload portions, wherein the PPDU comprises one or more predefined TFs preceding the one or more non-first-in-order data payload portions, respectively.

Example 24 includes the subject matter of any one of Examples 1-23, and optionally, wherein the preamble comprises a non High Throughput (HT) Short Training Field (L-STF), wherein the predefined TF is different from the L-STF.

Example 25 includes the subject matter of any one of Examples 1-24, and optionally, wherein the PPDU comprises one or more first-STA data payload portions for a first STA, and one or more second-STA data payload portions for a second STA after the one or more first-STA data payload portions, wherein the PPDU comprises another preamble between the one or more first-STA data payload portions and the one or more second-STA data payload portions.

Example 26 includes the subject matter of any one of Examples 1-25, and optionally, wherein the PPDU frame format comprises a Short-Inter-Frame-Space (SIFS) or a Point Coordination Function (PCF) Inter-Frame-Space (PIFS) between the first data payload portion and the predefined TF prior to the second data payload portion.

Example 27 includes the subject matter of any one of Examples 1-26, and optionally, wherein the PPDU comprises an Ultra High Reliability (UHR) PPDU, wherein the preamble of the PPDU comprises a plurality of pre-UHR modulated fields followed by a plurality of UHR modulated fields.

Example 28 includes the subject matter of Example 27, and optionally, wherein the plurality of pre-UHR modulated fields comprises a non High Throughput (HT) Short Training Field (L-STF), a non-HT Long Training Field (L-LTF) after the STF, a non-HT Signal (L-SIG) field after the L-LTF, a Repeated L-SIG (RL-SIG) field after the L-SIG field, and a Universal SIG (U-SIG) field after the RL-SIG field, wherein the plurality of UHR modulated fields comprises a UHR Signal (UHR-SIG) field, a UHR Short Training Field (UHR-STF) after the UHR-SIG field, and a UHR Long Training Field (UHR-LTF) after the UHR-STF.

Example 29 includes the subject matter of Example 28, and optionally, wherein the U-SIG comprises a frame format indication field to indicate the PPDU frame format.

Example 30 includes the subject matter of any one of Examples 27-29, and optionally, wherein the predefined TF comprises a UHR TF.

Example 31 includes the subject matter of any one of Examples 27-30, and optionally, wherein the predefined TF comprises a UHR Short TF (UHR-STF) or a UHR Long TF (UHR-LTF).

Example 32 includes the subject matter of any one of Examples 1-31, and optionally, comprising a radio to transmit the PPDU.

Example 33 includes the subject matter of Example 33, and optionally, comprising one or more antennas connected to the radio, and a processor to execute instructions of an operating system of the STA.

Example 34 includes an apparatus comprising logic and circuitry configured to cause a wireless communication Station (STA) to process a preamble of a received Physical Layer (PHY) Protocol Data Unit (PPDU) according to a PPDU frame format; and process a data payload of the received PPDU according to the PPDU frame format, the data payload comprising a plurality of data payload portions, wherein the PPDU comprises a predefined Training Field (TF) between a first data payload portion and a second data payload portion of the plurality of data payload portions.

Example 35 includes the subject matter of Example 34, and optionally, wherein the received PPDU comprises an Aggregate PHY Service Data Unit (PSDU) (A-PSDU) according to an A-PSDU frame format, wherein the plurality of data payload portions comprises a plurality of PSDUs.

Example 36 includes the subject matter of Example 35, and optionally, wherein the A-PSDU comprises a PSDU header between a first PSDU and a second PSDU of the plurality of PSDUs, wherein the PSDU header comprises the predefined TF.

Example 37 includes the subject matter of Example 36, and optionally, wherein the predefined TF comprises a Short Training Field (STF).

Example 38 includes the subject matter of Example 37, and optionally, wherein the PSDU header comprises a Long Training Field (LTF) after the STF.

Example 39 includes the subject matter of any one of Examples 36-38, and optionally, wherein the PSDU header comprises a Signal (SIG) field after the predefined TF, wherein the SIG field comprises a length field to indicate a length of the second PSDU.

Example 40 includes the subject matter of Example 39, and optionally, wherein the SIG field comprises a Modulation and Coding Scheme (MCS) field to indicate an MCS of the second PSDU.

Example 41 includes the subject matter of Example 39 or 40, and optionally, wherein the SIG field comprises a last-PSDU indication field to indicate whether or not the second PSDU is a last PSDU in the A-PSDU.

Example 42 includes the subject matter of any one of Examples 39-41, and optionally, wherein the SIG field comprises a Light SIG (Li-SIG) field.

Example 43 includes the subject matter of Example 42, and optionally, wherein the Li-SIG field is shorter than a SIG field in the preamble of the received PPDU.

Example 44 includes the subject matter of any one of Examples 36-43, and optionally, wherein the A-PSDU frame format comprises a Short-Inter-Frame-Space (SIFS) or a Point Coordination Function (PCF) Inter-Frame-Space (PIFS) between the first PSDU and the PSDU header prior to the second PSDU.

Example 45 includes the subject matter of any one of Examples 35-44, and optionally, wherein the A-PSDU comprises one or more first-STA PSDUs for a first STA, and one or more second-STA PSDUs for a second STA after the one or more first-STA PSDUs, wherein the A-PSDU comprises another preamble between the one or more first-STA PSDUs and the one or more second-STA PSDUs.

Example 46 includes the subject matter of any one of Examples 35-45, and optionally, wherein the preamble comprises a frame format indication field configured to indicate that the received PPDU is configured according to the A-PSDU frame format.

Example 47 includes the subject matter of Example 34, and optionally, wherein the received PPDU comprises a fragmented PPDU according to a fragmented PPDU frame format, wherein the plurality of data payload portions comprises a plurality of PPDU fragments, wherein the predefined TF is between a first PPDU fragment and a second PPDU fragment.

Example 48 includes the subject matter of Example 47, and optionally, wherein the fragmented PPDU frame format comprises a fixed fragmentation duration for a plurality of PPDU portions corresponding to the plurality of PPDU fragments.

Example 49 includes the subject matter of Example 47 or 48, and optionally, wherein a duration of a first-in-order PPDU portion of the fragmented PPDU is equal to a duration of a non-first-in-order PPDU portion of the fragmented PPDU, wherein the first-in-order PPDU portion comprises the preamble of the PPDU and a first-in-order PPDU fragment of the plurality of PPDU fragments, wherein the non-first-in-order PPDU portion comprises the predefined TF and a non-first-in-order PPDU fragment of the plurality of PPDU fragments.

Example 50 includes the subject matter of any one of Examples 47-49, and optionally, wherein the predefined TF comprises a Short TF (STF) or a Long TF (LTF).

Example 51 includes the subject matter of any one of Examples 47-50, and optionally, wherein the fragmented PPDU comprises one or more first-STA PPDU fragments for a first STA, and one or more second-STA PPDU fragments for a second STA after the one or more first-STA PPDU fragments, wherein the fragmented PPDU comprises another preamble between the one or more first-STA PPDU fragments and the one or more second-STA PPDU fragments.

Example 52 includes the subject matter of any one of Examples 47-51, and optionally, wherein the fragmented PPDU frame format comprises a Short-Inter-Frame-Space (SIFS) or a Point Coordination Function (PCF) Inter-Frame-Space (PIFS) between the first PPDU frame fragment and the predefined TF prior to the second PPDU fragment.

Example 53 includes the subject matter of any one of Examples 47-52, and optionally, wherein the preamble comprises a duration field to indicate a length of a fixed fragment duration for the fragmented PPDU.

Example 54 includes the subject matter of any one of Examples 47-53, and optionally, wherein the preamble comprises a frame format indication field configured to indicate that the received PPDU is configured according to the fragmented PPDU frame format.

Example 55 includes the subject matter of any one of Examples 34-54, and optionally, wherein the received PPDU comprises the predefined TF preceding each non-first-in-order data payload portion of the plurality of data payload portions.

Example 56 includes the subject matter of any one of Examples 34-55, and optionally, wherein the received PPDU comprises a first-in-order data payload portion followed by one or more non-first-in-order data payload portions, wherein the received PPDU comprises one or more predefined TFs preceding the one or more non-first-in-order data payload portions, respectively.

Example 57 includes the subject matter of any one of Examples 34-56, and optionally, wherein the preamble comprises a non High Throughput (HT) Short Training Field (L-STF), wherein the predefined TF is different from the L-STF.

Example 58 includes the subject matter of any one of Examples 34-57, and optionally, wherein the received PPDU comprises one or more first-STA data payload portions for a first STA, and one or more second-STA data payload portions for a second STA after the one or more first-STA data payload portions, wherein the received PPDU comprises another preamble between the one or more first-STA data payload portions and the one or more second-STA data payload portions.

Example 59 includes the subject matter of any one of Examples 34-58, and optionally, wherein the PPDU frame format comprises a Short-Inter-Frame-Space (SIFS) or a Point Coordination Function (PCF) Inter-Frame-Space (PIFS) between the first data payload portion and the predefined TF prior to the second data payload portion.

Example 60 includes the subject matter of any one of Examples 34-59, and optionally, wherein the received PPDU comprises an Ultra High Reliability (UHR) PPDU, wherein the preamble of the received PPDU comprises a plurality of pre-UHR modulated fields followed by a plurality of UHR modulated fields.

Example 61 includes the subject matter of Example 60, and optionally, wherein the plurality of pre-UHR modulated fields comprises a non High Throughput (HT) Short Training Field (L-STF), a non-HT Long Training Field (L-LTF) after the STF, a non-HT Signal (L-SIG) field after the L-LTF, a Repeated L-SIG (RL-SIG) field after the L-SIG field, and a Universal SIG (U-SIG) field after the RL-SIG field, wherein the plurality of UHR modulated fields comprises a UHR Signal (UHR-SIG) field, a UHR Short Training Field (UHR-STF) after the UHR-SIG field, and a UHR Long Training Field (UHR-LTF) after the UHR-STF.

Example 62 includes the subject matter of Example 61, and optionally, wherein the U-SIG comprises a frame format indication field to indicate the PPDU frame format.

Example 63 includes the subject matter of any one of Examples 60-62, and optionally, wherein the predefined TF comprises a UHR TF.

Example 64 includes the subject matter of any one of Examples 60-63, and optionally, wherein the predefined TF comprises a UHR Short TF (UHR-STF) or a UHR Long TF (UHR-LTF).

Example 65 includes the subject matter of any one of Examples 34-64, and optionally, comprising a radio to receive the received PPDU.

Example 66 includes the subject matter of Example 65, and optionally, comprising one or more antennas connected to the radio, and a processor to execute instructions of an operating system of the STA.

Example 67 comprises a wireless communication device comprising the apparatus of any of Examples 1-66.

Example 68 comprises a mobile device comprising the apparatus of any of Examples 1-66.

Example 69 comprises an apparatus comprising means for executing any of the described operations of any of Examples 1-66.

Example 70 comprises a product comprising one or more tangible computer-readable non-transitory storage media comprising instructions operable to, when executed by at least one processor, enable the at least one processor to cause a wireless communication device to perform any of the described operations of any of Examples 1-66.

Example 71 comprises an apparatus comprising: a memory interface; and processing circuitry configured to: perform any of the described operations of any of Examples 1-66.

Example 72 comprises a method comprising any of the described operations of any of Examples 1-66.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication Station (STA) to:
generate a preamble of a Physical Layer (PHY) Protocol Data Unit (PPDU) according to a PPDU frame format;
generate a data payload of the PPDU according to the PPDU frame format, the data payload comprising a plurality of data payload portions, wherein the PPDU comprises a predefined Training Field (TF) between a first data payload portion and a second data payload portion of the plurality of data payload portions; and
transmit the PPDU.

2. The apparatus of claim 1, wherein the PPDU comprises an Aggregate PHY Service Data Unit (PSDU) (A-PSDU) according to an A-PSDU frame format, wherein the plurality of data payload portions comprises a plurality of PSDUs.

3. The apparatus of claim 2, wherein the A-PSDU comprises a PSDU header between a first PSDU and a second PSDU of the plurality of PSDUs, wherein the PSDU header comprises the predefined TF.

4. The apparatus of claim 3, wherein the predefined TF comprises a Short Training Field (STF).

5. The apparatus of claim 3, wherein the PSDU header comprises a Signal (SIG) field after the predefined TF, wherein the SIG field comprises a length field to indicate a length of the second PSDU.

6. The apparatus of claim 3, wherein the A-PSDU frame format comprises a Short-Inter-Frame-Space (SIFS) or a Point Coordination Function (PCF) Inter-Frame-Space (PIFS) between the first PSDU and the PSDU header prior to the second PSDU.

7. The apparatus of claim 2, wherein the A-PSDU comprises one or more first-STA PSDUs for a first STA, and one or more second-STA PSDUs for a second STA after the one or more first-STA PSDUs, wherein the A-PSDU comprises another preamble between the one or more first-STA PSDUs and the one or more second-STA PSDUs.

8. The apparatus of claim 1, wherein the PPDU comprises a fragmented PPDU according to a fragmented PPDU frame format, wherein the plurality of data payload portions comprises a plurality of PPDU fragments, wherein the predefined TF is between a first PPDU fragment and a second PPDU fragment.

9. The apparatus of claim 8, wherein the fragmented PPDU frame format comprises a fixed fragmentation duration for a plurality of PPDU portions corresponding to the plurality of PPDU fragments.

10. The apparatus of claim 1, wherein the PPDU comprises the predefined TF preceding each non-first-in-order data payload portion of the plurality of data payload portions.

11. The apparatus of claim 1, wherein the PPDU comprises a first-in-order data payload portion followed by one or more non-first-in-order data payload portions, wherein the PPDU comprises one or more predefined TFs preceding the one or more non-first-in-order data payload portions, respectively.

12. The apparatus of claim 1, wherein the preamble comprises a non High Throughput (HT) Short Training Field (L-STF), wherein the predefined TF is different from the L-STF.

13. The apparatus of claim 1, wherein the PPDU comprises one or more first-STA data payload portions for a first STA, and one or more second-STA data payload portions for a second STA after the one or more first-STA data payload portions, wherein the PPDU comprises another preamble between the one or more first-STA data payload portions and the one or more second-STA data payload portions.

14. The apparatus of claim 1, wherein the PPDU frame format comprises a Short-Inter-Frame-Space (SIFS) or a Point Coordination Function (PCF) Inter-Frame-Space (PIFS) between the first data payload portion and the predefined TF prior to the second data payload portion.

15. The apparatus of claim 1, wherein the PPDU comprises an Ultra High Reliability (UHR) PPDU, wherein the preamble of the PPDU comprises a plurality of pre-UHR modulated fields followed by a plurality of UHR modulated fields.

16. The apparatus of claim 1 comprising a radio to transmit the PPDU.

17. The apparatus of claim 16 comprising one or more antennas connected to the radio, and a processor to execute instructions of an operating system of the STA.

18. A product comprising one or more tangible computer-readable non-transitory storage media comprising instructions operable to, when executed by at least one processor, enable the at least one processor to cause a wireless communication Station (STA) to:
generate a preamble of a Physical Layer (PHY) Protocol Data Unit (PPDU) according to a PPDU frame format;
generate a data payload of the PPDU according to the PPDU frame format, the data payload comprising a plurality of data payload portions, wherein the PPDU comprises a predefined Training Field (TF) between a first data payload portion and a second data payload portion of the plurality of data payload portions; and
transmit the PPDU.

19. The product of claim 18, wherein the PPDU comprises an Aggregate PHY Service Data Unit (PSDU) (A-PSDU) according to an A-PSDU frame format, wherein the plurality of data payload portions comprises a plurality of PSDUs.

20. The product of claim 18, wherein the PPDU comprises a fragmented PPDU according to a fragmented PPDU frame format, wherein the plurality of data payload portions comprises a plurality of PPDU fragments, wherein the predefined TF is between a first PPDU fragment and a second PPDU fragment.
